(19) United States
(12) Patent Application Publication
(10) Pub. No.: US 2002/0083760 A1
(43) Pub. Date: Jul. 4, 2002

(54) Heater tube

(75) Inventor: David L. Morris, San Antonio, TX (US)

Correspondence Address: Gunn, Lee, & Hanor, P.C., 700 N. St. Mary's Street, Suite 1500, San Antonio, TX, 78205, US

(73) Assignee: Standard Heater Tube, Inc., San Antonio, TX (US)

(21) Appl. No.: 09/943,189

(22) Filed: Aug. 30, 2001

Related U.S. Application Data
(60) Provisional application No. 60/229,624, filed on Aug. 31, 2000.

(51) Int. Cl. G01N 25/00

(52) U.S. Cl. 73/61.76

(57) ABSTRACT

A disposable heater tube for use in a machine testing the thermal oxidation characteristics of a fuel. The heater tube has a uniform and consistent work-hardened surface finish formed by burnishing. The finish is bright, smooth, and reflective and lacks the minute scratches. A process is also provided for burnishing the surface of a disposable heater tube. A burnishing machine is provided having a plurality of equally-spaced tapered rollers that roll around and bear against the inversely tapered inside surface of a rotating mandrel. A blank or raw heater tube is inserted between the tapered rollers inside the rotating mandrel. The tapered rollers are drawn inwardly against the outer surface of the blank or raw heater tube with just enough pressure to work harden the outer surface without elongating the tube.

### FIELD OF THE INVENTION

This application is based upon U.S. Provisional Patent Application Serial No. 60/229,624 filed Aug. 31, 2000, entitled “Heater Tube.”

This invention relates generally to the measurement of the thermal characteristics of hydrocarbon type fuel, and in particular to a heater tube, and a method for making the same, for use in the measurement of the thermal oxidation tendencies of aviation and turbine fuel.

### BACKGROUND OF THE INVENTION

Hydrocarbon type fuels flowing through a high temperature engine, such as a turbine engine, on its way to various combustion chambers typically comes into contact with hot surfaces. It is well known that at high enough temperatures, fuel will, without fully combusting, begin to oxidize and form deposits and fuel degradation products. These deposits can build up on fuel conduit surfaces and clog fuel passages including fuel nozzles and fuel filters, requiring more frequent maintenance of the engine's fuel system and possibly causing more serious problems. If such deposits are allowed to accumulate, and no intervening maintenance is performed on the engine, engine failure may result. This is of particular concern in jet aircraft engines.

The tendency of fuel to degrade at high temperatures depends on the type, composition, and quality of the fuel. More particularly, this tendency is called the “high temperature stability” or “thermal oxidation stability” of the fuel.

In the early 1970s, the American Society for Testing and Materials™ (ASTM) promulgated a Standard Test Method for Thermal Oxidation Stability of Aviation Turbine Fuels Procedure, giving it the fixed alphanumeric designation “ASTM D3241.” This published standard, most recently revised in 1997, is herein incorporated by reference. The specified test measures the high temperature stability of jet fuel by subjecting it to test conditions simulating those occurring in jet engine fuel systems.

The ASTM D3241 standard calls for an apparatus that, over a period of 2.5 hours, pumps 450 mL of pressurized fuel at a fixed volumetric flow rate around and over a long, thin, cylindrical, heated aluminum coupon (hereinafter “heater tube”) and through a precision stainless steel filter. The color and other characteristics of any fuel oxidation products (i.e., deposits) left on the heater tube, and the rate at which the precision filter is plugged by fuel degradation products, are then evaluated to assess the thermal stability of the test fuel.

Prior to testing, the fuel is filtered and aerated by passing dry air through the sample at a rate of 1.5 L/minute for 6 minutes, resulting in at least 97% saturation of the sample. This aeration process oxygenates the sample, facilitating oxidation of the fuel.

During the test, this oxygenated fuel is circulated around and over the heater tube at a pressure of about 500 pounds per square inch. The heater tube is maintained at a high temperature, typically 260° C. A thermocouple inserted deep into the heater tube measures the temperature. As pressurized, aerated fuel passes around and over the heater tube, clear or yellow-to-dark-colored decomposition products may be deposited on the tube. Excess solid fuel degradation products may be trapped by the filter.

At the conclusion of the test, the ASTM D3241 standard calls for the color of the heater tube deposits to be visually rated with reference to an ASTM color standard, using a device called a visual “tuberator.” A visual tuberator is a black box containing three 30 watt incandescent bulbs directed toward the heater tube and an ASTM color standard plate. The tuberator further comprises a viewing window, which magnifies the heater tube by a factor of three. The standard calls for a person “who can judge colors” to evaluate the color of the heater tube's darkest uniform deposit that covers an area equal to or larger than a circle of size one-half the diameter of the center portion of the heater tube.

Because the amount, color, and other characteristics of any heater tube deposit are affected by the surface finish of the tube, the standard calls for a pretest visual inspection for and rejection of any tube having scratches, dull, or unpolished areas or other defects “visible to the naked eye.” The standard also warns the user to carefully avoid touching the center portion of the heater tube, because dirt or oils from the skin may affect deposit formation on the tube. The standard further warns that heater tubes may not be cleaned and reused because, under normal test conditions, magnesium in the aluminum alloy heater tube tends to migrate to the heater tube surface, reducing adhesion of deposits to the heater tube surface. Accordingly, heater tubes are used once and may then be disposed of.

The heater tube is one of the most important components of the ASTM D3241 test. U.S. Pat. No. 3,670,561 (“the '561 patent”), issued Jun. 20, 1972, to Alf Hundere, and which is herein incorporated by reference, illustrates a heater tube and describes the tubular member employed as the heater tube as having a generally circular cross-sectional shape, a substantially constant internal diameter, and an outside diameter that is larger at the extremities than it is at the central portion. The '561 patent states a preference that the heater tube be constructed of aluminum, in order to minimize manufacturing cost. It also teaches that the internal diameter of the tube should range from between 1/16^{th} of an inch and ¼^{th} of an inch, and that the outer diameter of the central portion of the tube may be as low as ⅛^{th} of an inch. Furthermore, it teaches that the heater tube should have a highly polished surface finish that is consistent from tube to tube and is suitable for rating the level of fuel deposits obtained during a test. U.S. Pat. No. 5,101,658 (“the '658 patent”) and U.S. Pat. No. 5,337,599 (“the '599 patent”) similarly depict and describe a heater tube and are also incorporated herein by reference.

Another public domain reference, “Comparison of JFTOT Heater Tube Deposit Rating Methods for the Evaluation of Fuel Thermal Stability,” by Robert Morris, et. al., of the Naval Research Laboratory, published Dec. 29, 1987, discloses that a standard heater tube is manufactured from a common aluminum alloy known as 6061-T6 aluminum. 6061-T6 aluminum is an extremely popular alloy because of its low cost, good formability, corrosion resistance, high strength, and attractive appearance. 6061 aluminum comprises 0.8 to 1.20 percent magnesium, 0.4 to 0.8 percent silicon, 0.15 to 0.40 percent copper, 0.04 to 0.35 percent chromium, up to 0.7 percent iron, up to 0.25 percent zinc, up to 0.15 percent manganese, up to 0.15 percent titanium, up to 0.15 percent other elements, and the remainder aluminum.

Both the ASTM D3241 standard and the '658 and '599 patents teach that the heater tube is heated resistively by conducting a high amperage, low voltage current through the aluminum tube, in a manner similar to the way that metal coils of a space heater are heated by electricity. This method of heating, the '658 and '599 patents highlight, permits the inside of the tube to be left open so that its entire length may be probed for temperature measurement, and also permits the central portion of the tube to have a minimum outside diameter of ⅛ inch or less. Because the resistance of the tube varies inversely with the cross-sectional surface area of the tube, it is obvious that the thinner the tube and tube wall, the greater its resistance, and the less current that is needed to resistively heat the tube.

Disposable heater tubes for testing the thermal stability of fuels have been in existence for more than 30 years. Of course, dimensions of the heater tube not disclosed by the '561, '658, and '599 patents can be easily measured using a ruler or another more precise measuring instrument. A standard finished heater tube is approximately 6⅜ inches in length, including an approximately 2⅜ inch (or 60 mm) central portion. The central portion of the heater tube has an outer diameter of approximately ⅛ inch. The remainder of the heater tube has an outer diameter of approximately 3/16 inch. The inner diameter of the heater tube is slightly in excess of 1/16 inch, the standard diameter size of a thermocouple.

While the ASTM D3241 standard and the '561, '658, and '599 patents disclose various aspects of the heater tube and the need for a consistent, “highly polished” surface finish, these references do not describe a means, method, or best mode for obtaining an adequate and consistent surface finish. A SAE Technical Paper presented at the Aerospace Technology Conference & Exposition at Long Beach, Calif., between Oct. 14 and 17, 1985, by G. Datschefski and T. G. R. Farthing, entitled “Evaluation of JFTOT Tube Deposits by Carbon Burnoff” indicates that the industry's standard method of polishing heater tubes involves the application of a petroleum distillate-based metal polishing liquid containing ammonia.

Polishes consist of an abrasive material suspended in wet lapping. The abrasive material in the polish cuts thousands of tiny grooves into the surface of the workpiece. Because these random scratches are so small, this gives the surface a bright, reflective, and shiny appearance. In fact, the more numerous these tiny scratches, the brighter and more reflective the surface appears to the human eye. However, this does not mean it is a good finish. As Mr. Ted Busch pointed out on page 147 of his 1966 book, Fundamentals of Dimensional Metrology, a “buffed or polished surface may have good reflective qualities . . . [yet be] mistaken for a good surface finish.”

The ASTM D3241 standard test method calls for a visual inspection of the heater tube prior to use. It is common to pre-inspect the tube in the same tuberator used to evaluate the tube after the D3241 test has been performed. Surface finish quality defects and other inconsistencies, of course, become more apparent under the tuberator's magnification. Thus, the surface finish quality of a heater tube, and not merely surface reflectivity, is especially important.

For the past thirty years, commercially available heater tubes have been conventionally polished. Examination of such heater tubes under more powerful magnification than the tuberator offers reveals the random pattern of scratches left by the polishing process. I believe that these random patterns of scratches may conceal defects in the surface finish quality. I also believe that they may interfere with automated analysis of heater tube deposits, thereby reducing the accuracy or reliability of some tube deposit measuring devices.

Some tube deposit measuring devices, such as the “Interferometric JFTOT tube deposit measuring device” disclosed in U.S. Pat. No. 5,293,218, attempt to calculate the thickness of a degraded fuel film deposit over the surface area of the central portion of the tube by evaluating interference patterns of reflected light from a coherent, single-wavelength light source. I believe that the reflection of incident coherent light, especially light of relatively low wavelengths, is phase-scattered by differentials (e.g., roughness) in the surface. If this is the case, then the consistency, quality and degree of flatness of the surface finish, and not merely its reflectivity, may very well affect the application of that or similar tests. Heater tube deposits often do not exceed 500 nm in thickness. Therefore, to have much confidence in common contemporary machine-based measurements of tube deposit thicknesses, I believe that surface inconsistencies, measured in terms of the depths of microscopic valleys with respect to microscopic ridges on the heater tube surface, should not exceed about 500 nm. Such consistent and uniform surface characteristics are presumably difficult, if not impossible, to achieve through conventional methods of polishing.

More than ten years ago, I and others spent about a year attempting to develop a new method of finishing heater tubes by burnishing them. Our efforts at that time were unsuccessful in making satisfactorily finished tubes. We abandoned the effort to burnish heater tubes, and some concluded that it was an impossible or infeasible means to finish heater tubes. After thinking about my prior failure, I recently renewed my efforts at my own expense to satisfactorily finish a tube by burnishing it. Despite the persistent doubts of others, I have overcome the problems that hindered my earlier efforts. Even after I showed my invention to those skilled in the art they disbelieved that I could successfully do it.

Therefore, there is a long-felt need for a more uniform, consistent, flat, and cost-effective surface finish than that which can be provided by polishing. There is also a long-felt need for objective methods for evaluating fuel thermal oxidation characteristics and for a fuel degradation deposit substrate having a surface finish that facilitates such a method. There is a further need for a method of obtaining a fine surface finish that does not require the use of environmentally unfriendly chemical polishing agents.

Other problems and disadvantages of prior art systems can be appreciated by one of ordinary skill in the art after examination of such prior art and in view of the present disclosure.

### SUMMARY

The present invention provides a heater tube, and a process for manufacturing the same, that has a uniform and consistent work-hardened surface finish. This tube itself is substantially flat and generally free of the minute scratches resulting from other methods of finishing heater tubes. The heater tube may be comprised of hollow, elongated, seamless steel, titanium, brass, or aluminum tubing, or other suitable material. The tube has a reduced-diameter central portion, the outer surface of which is carefully burnished. This central portion then acts as a substrate for depositing partially oxidized fuel degradation products. The burnished surface finish is also bright and reflective, which facilitates visual inspection and rating of the fuel-related degradation products.

A process is also provided for burnishing a heater tube. A burnishing machine is provided, having a plurality of equally-spaced tapered rollers that roll around and bear against an inversely tapered inside surface of a rotating mandrel. A metallic workpiece is inserted between the tapered rollers inside the rotating mandrel. The tapered rollers are drawn inwardly against the outer surface of the metallic workpiece in order to provide a steady rolling pressure against the outer surface of the metallic workpiece.

A process is also provided for testing the thermal characteristics of a fuel. The central portion of a burnished heater tube is heated to a temperature sufficient to cause partial oxidation of the fuel. The fuel is pressurized and passed around the burnished surface of the coupon's central portion for a sufficient length of time to permit the deposition of fuel degradation products onto the burnished surface. The fuel degradation product deposits on the burnished surface are evaluated in any conventional manner to test the thermal characteristics of the fuel.

An object of the invention is to provide an improved method for finishing coupons and heater tubes. An object of the invention is to provide an improved method for finishing thin-wall soft metal tubing. Another object of the invention is to provide coupons and heater tubes with an improved surface finish. Another object of the invention is to provide coupons and heater tubes with improved characteristics. Another object of the invention is to provide coupons and heater tubes with improved performance. Another object of the invention is to provide an improved apparatus and method for testing fuels and other combustible products. These objects are separate and distinct from one another and are not intended to mutually or collectively limit the scope of the invention which is defined by the claims. Other objects and aspects of the invention will be more clearly understood after reference to the following detailed description read in conjunction with the drawings.

### BRIEF DESCRIPTION OF THE DRAWINGS

FIG. 1A is a microscopic side view illustration of a fine surface finish.

FIG. 1B is a microscopic side view illustration of a poor surface finish with high reflectivity.

FIG. 2 is a side view of one embodiment of a heater tube for use in a fuel thermal stability testing apparatus.

FIG. 3 is a side view of a cross section of a portion of a burnishing machine for burnishing a heater tube in accordance with one embodiment of the present invention.

FIG. 4 is a flow diagram of one embodiment of a process for burnishing a raw heater tube, utilizing one embodiment of the burnishing machine of FIG. 3.

FIG. 5 is a three-dimensional profile of the surface of a burnished heater tube created in accordance with the present invention.

### DETAILED DESCRIPTION

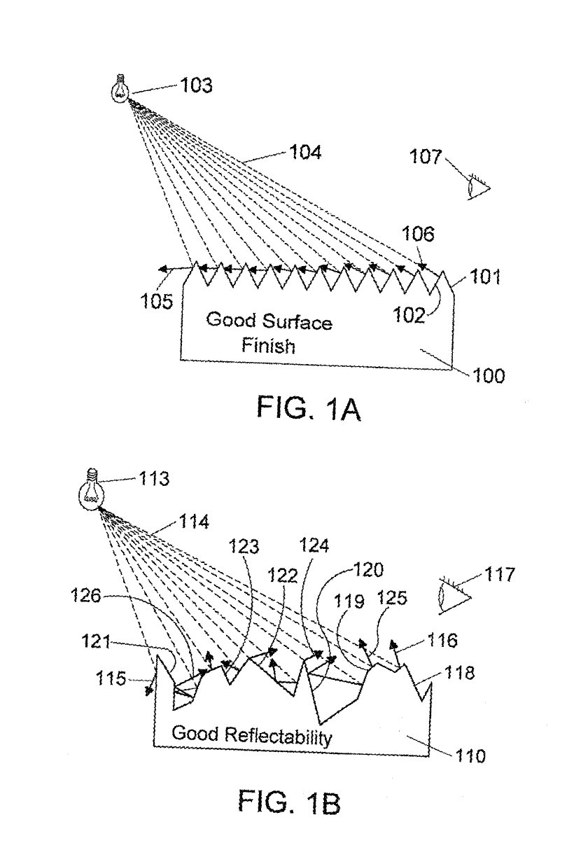

FIG. 1A shows a representation of a very good surface finish of a tube portion 100 having a regular surface area with peaks having relatively uniformly inclined walls 101 and 102. The light source 103 directs beams of light 104 to the inclined walls and reflects the light as represented by 105 and 106. All of this, is visually ascertained by an eye 107.

FIG. 1B shows a representation of a very rough irregular surface finish of a tube portion 110 having peaks with non-uniform inclined walls 118, 119, 120, 121, 122 and 123. The light source 113 directs beams of light 114 to the inclined walls and reflects the light as represented by 115, 116, 124, 125 and 126. All of this is visually ascertained by a eye 117. In the case of a heater tube, the highly irregular surface interferes with the evaluation of a coating of burnt fuel products on the surface.

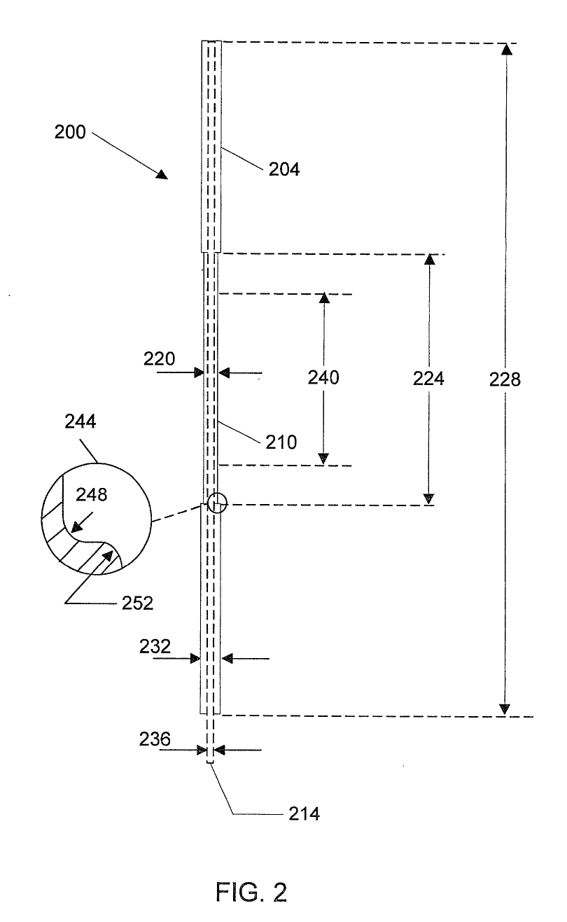

FIG. 2 is a side view of one embodiment of a standard disposable heater tube 200 for use in a fuel thermal stability testing apparatus. The dimensions and tolerances of the standard disposable heater tube 200 are constrained by the requirements of the commercially-available jet fuel thermal oxidation testers (JFTOTs) in which they are used. These JFTOTs have been sold for about thirty years and the dimensions of the disposable heater tubes have remained substantially the same throughout that time. The heater tube 200 has a length 228 of approximately 6⅜ inches and an inner diameter 236 of approximately 1/16 inch. The heater tube 200 also has two end portions 204 with an outer diameter 232 of approximately 3/16 inch. These end portions 204 fit into the O-ring seals of a heater tube housing of a JFTOT device described and built in accordance with the '561, '658, or '599 patents. The heater tube 200 also has a central portion 210 with a length 224 of approximately 2⅜ inches or 60 millimeters and a diameter 220 of approximately ⅛ inch.

FIG. 2 also displays an exploded view of a shoulder 244, located at the transition from the end portion 204 to the central portion 210 of the heater tube 200. The shoulder 244 has an inside shoulder radius 248 and an outside shoulder radius 252. The particular dimensions of the shoulder radii 248 and 252 are not critical in performing the ASTM D3241 test, provided that the shoulders are, as the ASTM D3241 standard test method teaches, smooth and unscratched to ensure a proper seal with the O-rings. The dimensions of the shoulder radii 248 and 252 do, however, affect the reflectivity or apparent brightness of the central portion 210 of the heater tube immediately adjacent to the shoulder 244. Accordingly, in the exemplary embodiment, the shoulder radii 248 and 252 are approximately 0.015 inches.

Heater tubes may be manufactured out of many different kinds of metal, including aluminum, carbon steel, stainless steel, brass, and titanium. The ASTM D3241 standard test method teaches that the heater tube be made of an aluminum alloy containing magnesium. 6061-T6 aluminum is suitable because it possesses an attractive appearance and is an inexpensive, heat-treatable aluminum alloy having good formability and corrosion resistance with high strength.

An aluminum heater tube is manufactured by cutting seamless aluminum tubing having an inner diameter of approximately 1/16 inch and an outer diameter slightly in excess of 3/16 inch into approximately 6⅜-inch segments, and then reducing the outer diameter of the central 2⅜-inch portion of the segment to approximately ⅛ inch, and the outer diameter of the end portions to approximately 3/16 inch, using a lathe or other machining methods familiar to persons of ordinary skill in the art of metal working.

The required dimensional tolerances of a heater tube are dictated by the processes used to manufacture and finish the heater tube and by the JFTOT instruments in which the heater tube is to be used. The type of machine used and the skill of the operator determine the precision with which certain dimensions can be obtained. The tolerances achievable with a given machine are well known to skilled machinists and the manufacturers of metal forming machines.

With respect to the heater tube 200, the inner diameter 236 should be wide enough to permit the small, common, commercially-available thermocouple (i.e., 1/16-inch diameter) to pass freely through the tube orifice 214. The outer diameter 220 of the central portion 224 should be narrow enough to permit the JFTOT to resistively heat the tube to at least 260° C. using a standard 220-V or less power source. At the same time, the tube wall should be thick enough to withstand the compressive forces of a roller burnisher used to finish the surface. Also, the diameter 232 of the end portions 204 should be precise enough to prevent fuel leakage when inserted into the O-rings of the JFTOT machine. Fortunately, these constraints permit dimensional variations of up to a tenth of a millimeter. Such tolerances are easily attainable using modem manufacturing and machining equipment, which is capable of achieving dimensional tolerances of less than 10 angstroms.

Of course, other disposable coupons with entirely different dimensions, compositions, and configurations may act as suitable substrates for accepting fuel degradation products. For example, other means could be used to heat the central portion of the heater tube, eliminating the rationale of having a slender, reduced-diameter central portion to facilitate resistive heating. Also, remote temperature sensing means could be used to measure the temperature of the central portion, eliminating the rationale of having a tube, instead of a solid rod, to facilitate the insertion of a thermocouple to measure the tube temperature. Other suitable coupons could be made and used in accordance with many aspects of the present invention without utilizing heater tubes having the configurations, compositions and dimensions to which those skilled in the art have grown accustomed over the past thirty years. Accordingly, the present invention is not intended to be limited solely to heater tubes having these familiar configurations, compositions, and dimensions.

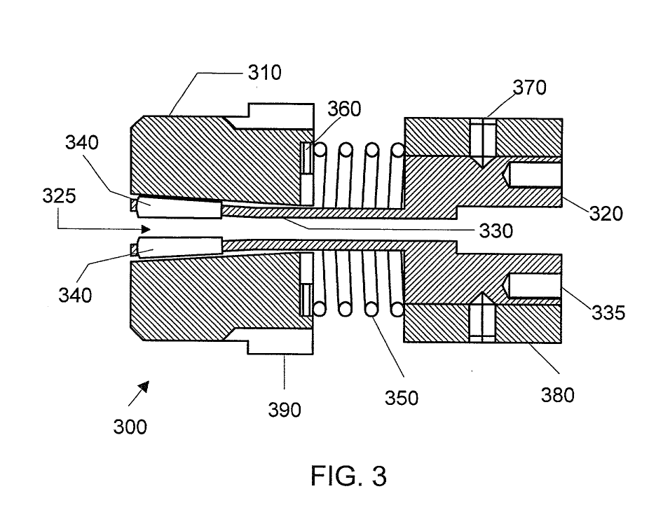

FIG. 3 is a side view of a cross section of a burnishing machine assembly 300 for burnishing a heater tube in accordance with one embodiment of the present invention. Three or more equally-spaced, identical, hardened, highly-finished, precision-tapered, steel burnishing rollers 340 roll around and bear against an inversely tapered rotating mandrel 310, applying steady rolling pressure against the surface of a workpiece that is slowly inserted into aperture 325. The plurality of rollers 340 are held in place by a removable cage 320 comprising rods 330 about which the rolls 340 are rotatably disposed. A cage retainer 380 retains the removable cage 320 by means of set screws 370. A spring 350 connects the cage 320 and cage retainer 380 to the rotating mandrel 310 by means of thrust race and bearings 360. Recesses 335 permit the insertion of rods (not shown) to advance the cage 320 along the cylindrical axis of the rotating mandrel 310. Furthermore, an air pressure mechanism (not shown) causes the cage 320 and rollers 340 to advance and retract within and along the cylindrical axis of the rotating mandrel 310, expanding or shrinking the aperture 325 accordingly.

To burnish a metal cylindrical workpiece, the workpiece is inserted into the aperture 325 at the center of the mandrel 310. As the mandrel 310 rotates, it causes the burnishing rollers 340 to rotate in the opposite direction and forces them inwardly against the outer surface of the workpiece. The steady rolling pressure applied to the outer surface of the workpiece “work hardens” the metallic surface of the workpiece by pushing the microscopic crystalline metal peaks of the surface into the crystalline metal valleys of the surface. As burnishing progresses, air pressure applied to the burnishing machine assembly 300 causes the cage 320 to retract, reducing the size of the aperture 325 and increasing the magnitude of the force applied by the rollers 340 on the surface of the workpiece.

Roller burnishing applies high force to a workpiece. To be effective, the burnishing rollers 340 should apply force that exceeds the yield strength of the surface of the metal being finished. Optimally, the pressure is significant enough to cause the crystalline surface peaks to flow into the crystalline surface valleys of the workpiece, but not strong enough to elongate the workpiece. Accordingly, the amount of pressure required for burnishing depends on the diameter and shape of the burnishing rollers 340, the diameter, shape, ductility, and tensile strength of the workpiece, the surface roughness of the workpiece before burnishing, and the surface smoothness of the workpiece required after burnishing.

The effect of roller burnishing on a metal workpiece is called “work hardening” because it hardens the surface, making it less ductile and more resistant to deformation. The workpiece is hardened because once the surface crystalline peaks are pushed or “smeared” into the surface crystalline valleys, the surface resists further deformation. The process produces a mirror-like surface that is remarkably fine, smooth and flat, highly reflective, and resistant to wear and corrosion. The skill of the operator of the burnishing machine is also a factor in determining the quality of the finished surface on the product being burnished.

Polishing, by contrast, scratches the surface. Like burnishing, polishing can produce a highly reflective, bright, and mirror-like surface finish. But unlike burnishing, the multiple random scratches on the surface, not the flatness of the surface, is responsible for any perceived brightness. A polished surface, moreover, will experience surface oxidation or corrosion more quickly than a burnished surface, because the microscopic gouges and ridges in the surface exposes more surface material to the elements than a flat surface does.

Comparing a polished surface to a burnished surface under 10-40 magnification will reveal several differences in surface finish. A burnished surface will typically have a smooth, uniform, and very fine pattern of smear marks. A polished surface will typically have a random pattern of scratches.

There are other advantages of roller burnishing a cylindrical or tubular workpiece. The rotational process uniformly burnishes the entire cylindrical surface area of the workpiece. Roller burnishing also finishes a surface much faster than typical polishing processes.

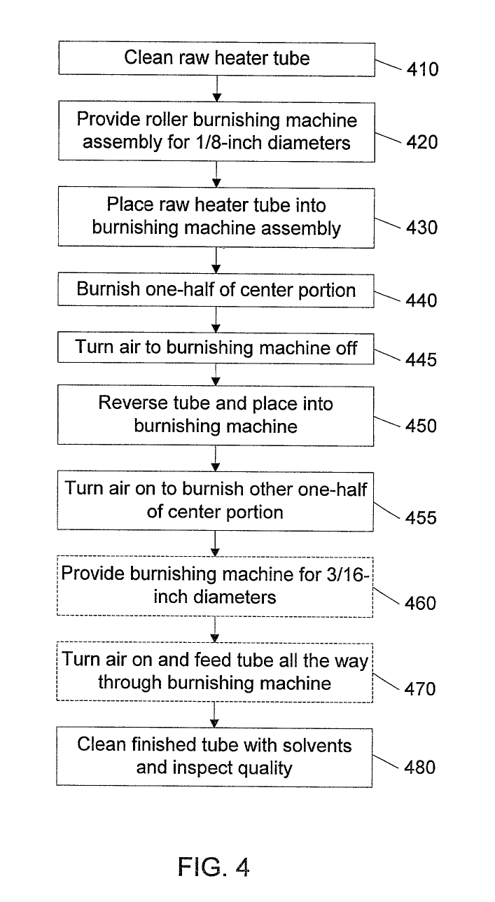

FIG. 4 is a flow diagram of one embodiment of a process for burnishing a blank or raw heater tube, utilizing one embodiment of the burnishing machine assembly 300 of FIG. 3.

In step 410, a blank or raw heater tube 200 (FIG. 2) is cleaned with a suitable cleaning agent or solvent such as hexane, to remove any dirt or debris. Dirt or debris should be removed to avoid having it ground into the surface by the burnishing machine. Any paraffin-based lubricant residue remaining from the machining of the raw heater tubes 200 should also be removed to avoid contamination with ester-based or synthetic lubricants used in conjunction with burnishing steps 440, 455, and 470. Such residue can often be detected under lighting and proper magnification as a brightly colored red, green, or blue film on the raw heater tube 200.

In step 420, a conventional burnishing machine assembly 300 (FIG. 3) is provided having the proper mandrel 310, cage 320, and rollers 340 for burnishing the central portion 210 (FIG. 2) of the blank or raw heater tube 200, which has a central diameter of ⅛-inch. In one conventional burnishing machine assembly used in the development of this invention, a spring (not shown) in the air pressure regulator (not shown) that caused the rollers 340 to advance or retract within the rotating mandrel 310 was replaced with a weaker spring, allowing for precise adjustment of the air pressure, in a range between 0 and 30 pounds per square inch.

Depending on the burnishing machine assembly 300 used, different mandrels 310, cages 320, and rollers 340 may be required to burnish the 3/16-inch and ⅛-inch diameter portions of the tube. For the ⅛-inch diameter portion, a mandrel (also called a race) was selected having a tapered bore whose diameter progresses from approximately 0.48 inches on one end to approximately 0.75 inches at the other end. The mandrel 310 was approximately 2.36 inches long from end to end. Three tapered rollers 340 were selected that have a length of approximately 0.81 inches from end to end, and which vary in diameter from approximately 0.19 to 0.22 inches from end to end. This assembly 300 facilitates aperture 325 sizes ranging from approximately 0.09 to 0.31 inches.

In step 430, the blank or raw heater tube is placed partway into the aperture 325 (FIG. 3) of the burnishing machine assembly 300. In step 440, the tube is burnished from about the center of the tube to about the shoulder 244 (FIG. 2) of the tube. The burnishing machine's air pressure settings (not shown) are maintained at levels that produce just enough compressive force to exceed the yield strength of the surface of the blank or raw heater tube 200 without elongating the heater tube 200. The rotating mandrel 340 is maintained at a speed of approximately 100-300 rotations per minute (RPM). The conventional burnishing machine used in the development of this invention had a minimum mandrel speed of 700 RPM using a three-phase, 60 Hz, 220-volt power supply. To obtain lower speeds suitable for burnishing thin-walled heater tubes, a conventional inverter (not shown) was placed between a standard 220-volt power supply and the burnishing machine. The inverter converted the standard 60-Hertz frequency of the input power supply to a 3-phase 220-volt output with an adjustable alternating current frequency. Slower mandrel speeds are obtained by reducing the frequency of the inverter's output power to 3-30 Hz.

Operating materials accompanying the conventional burnishing machine used in the development of this invention recommended mandrel speeds in the vicinity of 2000 RPM for ⅛-inch diameter parts. These speeds, however, tended to leave tool marks near the shoulders 244 of the heater tube. Tool mark effects result from the fact that the heater tube stops advancing through the aperture 325 after the rollers 340 have burnished the tube from the midsection of the tube to the shoulders 244 of the tube. At high rotational speeds, the burnishing machine used in the development of this invention would not stop rotating quickly enough at the end of each burnishing operation. The inventor remedied this problem by rigging the burnishing machine to enable it to operate at slower speeds, which was contrary to the teachings of the prior art. As a result, a better and finer surface finish for heater tubes was achieved that left no, or at least much smaller, tool marks at the shoulders of the tube.

It is worth noting that because the diameter of the rollers 340 is smaller than the inner diameter of the mandrel 310, the rollers 340 rotate at approximately 2.5 times the RPM of the mandrel 310, and in the opposite spin direction. Accordingly, operating the mandrel at speeds of approximately 100 to 300 RPM results in roller RPMs of approximately 250 to 750 RPM. The heater tube 200 itself, whose diameter 220 (at the central portion 210) is even smaller than the diameter of the rollers 340, rotates at an even higher speeds, between approximately 400 and 1200 RPM.

In step 445, the air to the burnishing machine assembly 300 is turned off. In step 450, the tube is removed, reversed, and replaced into the aperture 325. In step 455, air to the burnishing machine assembly 300 is turned on again and the tube is burnished from about the center of the tube to about the other shoulder 244 of the tube.

In step 460, a burnishing machine assembly 300 is provided having a mandrel 310, cage 320, and rollers 340 with sizes and configurations appropriate for burnishing a 3/16-inch diameter cylindrical tube. The same burnishing machine can be used by disassembling and reassembling the machine with the proper mandrel 310, cage 320, and rollers 340.

With the burnishing machine assembly 300 used in the experimental development of this invention, the 3/16-inch diameter portions are burnished with a mandrel having a tapered bore whose diameter progresses from approximately 0.48 inches on one end to approximately 0.75 inches at the other end. The mandrel is approximately 1.25 inches long from end to end. Three tapered rollers are used having a length of approximately 0.625 inches from end to end, and which vary in diameter from approximately 0.138 to 0.161 inches from end to end. Because this set of rollers is even smaller than the rollers used for burnishing the central portion of the heater tube, they rotate at approximately 3.5 to 4.7 times the RPM of the mandrel. Accordingly, operating the mandrel at speeds of 100 to 300 RPM translates into roller speeds of approximately 350 to 1400 RPM. Because the end portions 204 of the heater tube 200 are wider than the rollers, the heater tube itself rotates at slower speeds of approximately 250 to 1600 RPM.

Of course, the present invention is not limited to the use of the burnishing machine assemblies 300 used in the experimental development of the invention. Different burnishing machines can be used. For example, a burnishing machine could be used in which the same mandrel 310, cage 320, and rollers 340 as provided in step 430 would also be appropriate for step 460. Alternatively, two separate burnishing machines could be used for the ⅛-inch and 3/16-inch diameter sections.

In step 470, the settings for the air pressure regulator (not shown) of the burnishing machine assembly 300 are adjusted to produce enough compressive force to exceed the yield strength of the surface of the raw heater tube 200 without elongating it. Because the end portions 204 of the heater tube are wider than the central portion, different air pressure and RPM settings may be warranted. With the air to the machine turned on, the raw heater tube 200 is then slowly fed all the way through the aperture 325 of the rotating mandrel 310, causing the end portions 204 to be burnished. Because the ASTM D3241 standard test method calls for heater tube deposits to be measured along only the central portion 210 of the heater tube 200, the surface finish of the end portions 204 is not critical. Accordingly, in another embodiment of the present invention, steps 460 and 470 are omitted altogether.

In steps 440, 455, and 470, a thick stream of lubricant is injected into the aperture 325 of the rotating mandrel 310 as the burnishing proceeds. The lubricant cools the rollers 340 and heater tube 200, preventing defects that would otherwise be caused by heat, abrasion, and friction.

In step 480, the finished heater tube 200 is cleaned, using an appropriate cleaner or solvent, to remove any lubricant, dirt, or other residue. The tube is also inspected to ensure that the process has resulted in an acceptable surface finish. Alternatively, a liquid cleaner or solvent can be fed to the working components of the burnishing assembly to simultaneously cool and lubricate the moving parts while also cleaning the heater tube in situ.

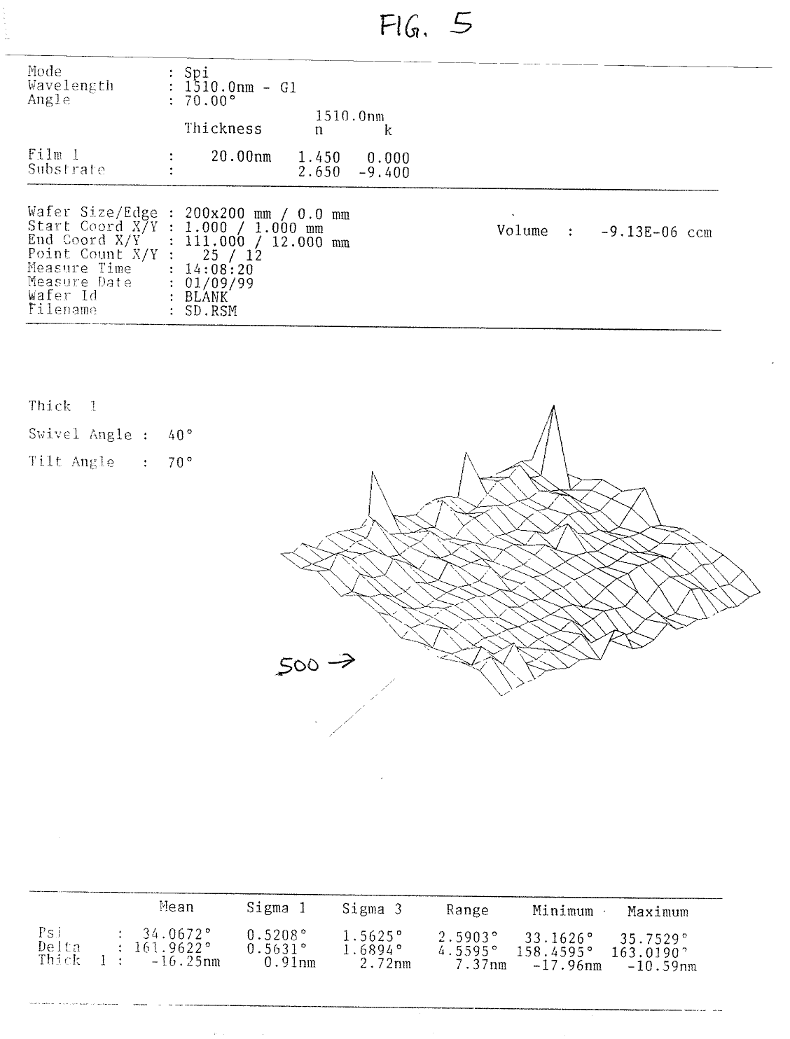

FIG. 5 illustrates a three-dimensional profile 500 of the flatness of the surface of a burnished heater tube made in accordance with the present invention. The profile 500 was generated with an Ellipsometric Test Analyzer (ETA), which measures the phase change of coherent laser light reflecting off of a surface. The thickness of a film overlaying a surface can be computed knowing the refractive index of the film and the variation in the phase of light reflected across the surface. To accurately measure the thickness of hydrocarbon-based films deposited on the surface of a heater tube with an ETA, I believe that the surface of the heater tube should be flat and clean enough to. cause incident coherent light to substantially maintain its coherence when it reflects off of the tube surface.

The test that produced the profile 500 shown in FIG. 5 was generated by reflecting coherent light with a wavelength of 1510 nm off of the heater tube surface at an angle of 70 degrees. The phase of the reflected light with respect to a reference phase was measured across the surface area of a portion of the heater tube. The relative phase difference varied within a relatively narrow band of 4.6 degrees. In other words, the coherent light incident upon the surface of the heater tube was reflected in a substantially coherent manner. This translated to a variation from perfect flatness across the surface area of the tube of no more than 7.37 nm.

I believe that having a flat heater tube surface will improve the accuracy of an ETA test of a heater tube deposit. I also believe that a flatness profile as good as that illustrated in FIG. 5 would introduce, at most, up to 7.37 nanometers of error into ETA measurements of the thickness of hydrocarbon deposits on the tube. Such flatness characteristics permit use of the ETA to confidently and objectively identify “Code 3” and “Code 4” deposits, described in the ASTM D3241 Standard Test Method, which are believed to typically range from eight to twenty nanometers thickness at the low end to 500 or more nanometers thickness at the high end.

This is not to suggest that every tube burnished in accordance with the present invention will necessarily obtain, or even need obtain, a flatness profile as good as that illustrated in FIG. 5. Some researchers in the relevant field of this invention have proposed 100-nm fuel-deposit film thicknesses as a pass/fail criteria for a fuel. I am confident that the present invention, unlike prior failed attempts, is capable of consistently producing heater tubes with surfaces that are flat within a range of 100-nm or less.

The present invention is capable of producing heater tubes that are superior to, albeit not identical to, heater tubes that are manufactured using polishing methods. I believe that burnishing is a faster and more cost-effective means of obtaining an acceptable surface finish for heater tubes employed in the ASTM D3241 standard test method than polishing. Furthermore, I believe that work-hardening the surface provides a flatter surface than what can be obtained with conventional methods of polishing. Accordingly, my invention is suitable not only for the ASTM D3241 test method, but also for other methods of evaluating fuel deposits, such as by measuring and calculating the thickness and volume of heater tube deposits with an ellipsometric tube analyzer. It is also worth noting that this invention is applicable not only for jet fuels but also for other kinds of fuels and combustible hydrocarbons used in high temperature environments.

Heater tubes are often marketed in kits that also contain precision filters for trapping fuel degradation products which do not adhere to the surface of the heater tube. The ASTM D3241 standard test method requires that the rate at which such filters are plugged, if at all, be part of the process used to evaluate the thermal characteristics of jet fuel. It is intended that the present invention extend also to complete heater tube kits that comprise a combination of both heater tubes and precision filters used in the ASTM D3241 standard test method. These precision filters may be comprised of stainless steel and/or aluminum parts.

While particular embodiments of the invention have been illustrated and described, it will be apparent to those of ordinary skill in the art that many more embodiments and implementations are possible within the scope of this invention. Accordingly, the invention is not to be restricted except in light of the attached claims and their equivalents.

What I claim is:

1. A disposable coupon for evaluation of thermal characteristics of fuels in a fuel testing machine, the coupon comprising:
a central portion that provides a substrate onto which partially oxidized fuel degradation products are deposited; and
a burnished surface finish on the central portion that facilitates visual inspection and rating of the fuel degradation product deposits.

2. The disposable coupon of claim 1, in which the central portion comprises an alloy of aluminum.

3. The disposable coupon of claim 1, in which the central portion comprises a 6061-T6 alloy of aluminum.

4. The disposable coupon of claim 1, in which the coupon comprises a seamless, substantially cylindrical tube formed of the group consisting of aluminum, steel, brass, and titanium.

5. The disposable coupon of claim 1, in which the burnished surface finish is consistent and uniform across the central portion.

6. The disposable coupon of claim 1, in which the burnished surface finish comprises a substantially uniform pattern of microscopic ridges and valleys.

7. The disposable coupon of claim 6, in which the median depth between the microscopic ridges and valleys on the burnished surface finish does not exceed 500 nanometers.

8. The disposable coupon of claim 6, in which the median depth between the microscopic ridges and valleys on the burnished surface finish does not exceed 100 nanometers.

9. The disposable coupon of claim 6, in which the median depth between the microscopic ridges and valleys on the burnished surface finish does not exceed 20 nanometers.

10. The disposable coupon of claim 6, in which the median depth between the microscopic ridges and valleys on the burnished surface finish does not exceed 10 nanometers.

11. The disposable coupon of claim 1, in which the burnished surface finish is flat enough to cause incident coherent light to substantially maintain its coherence when it reflects off the burnished surface finish.

12. The disposable coupon of claim 1, in which the burnished surface finish is flat enough to facilitate substantially accurate measurements and calculations of fuel deposit thicknesses using an ellipsometric tube analyzer.

13. The disposable coupon of claim 1, in which the burnished surface finish provides the central portion with a bright, smooth, and highly reflective appearance.

14. The disposable coupon of claim 1, further comprising a surface that is work hardened.

15. A coupon for evaluating thermal characteristics of combustible hydrocarbons comprising:
a metallic central portion that provides a substrate onto which partially oxidized hydrocarbon degradation products are deposited; and
a substantially unscratched surface finish on the central portion of the coupon that facilitates visual inspection and rating of the hydrocarbon degradation deposits.

16. The coupon of claim 15, in which the surface finish comprises a pattern of microscopic ridges and valleys having a median depth that does not exceed 500 nanometers.

17. The coupon of claim 15, in which the surface finish comprises a pattern of microscopic ridges and valleys having a median depth that does not exceed 100 nanometers.

18. The coupon of claim 15, in which the surface finish comprises a pattern of microscopic ridges and valleys having a median depth that does not exceed 20 nanometers.

19. The coupon of claim 15, in which the surface finish comprises a pattern of microscopic ridges and valleys having a median depth that does not exceed 10 nanometers.

20. The coupon of claim 15, in which the surface finish is flat enough to cause incident coherent light to substantially maintain its coherence when it reflects off the surface finish.

21. The coupon of claim 15, in which the surface finish is flat enough to facilitate substantially accurate measurements and calculations of hydrocarbon deposit thicknesses using an ellipsometric tube analyzer.

22. A coupon for evaluating thermal characteristics of fuels comprising:
a metallic central portion that provides a substrate onto which partially oxidized fuel degradation products are deposited; and
a surface finish on the central portion of the coupon that is flat enough to cause incident coherent light to substantially maintain its coherence when it reflects off the surface finish.

23. The coupon of claim 22, in which the coupon comprises a seamless aluminum alloy tube having a reduced diameter at the central portion.

24. A coupon for evaluating thermal characteristics of fuels comprising:
a metallic central portion that provides a substrate onto which partially oxidized fuel degradation products are deposited; and
a work-hardened surface finish on the central portion of the coupon that facilitates visual inspection and rating of the fuel degradation product deposits.

25. The coupon of claim 24, in which the coupon comprises a seamless aluminum alloy tube having a reduced diameter at the central portion.

26. A coupon for evaluating thermal characteristics of fuels comprising:
a metallic central portion that provides a substrate onto which partially oxidized fuel degradation products are deposited;
a surface that is originally characterized by microscopic ridges and valleys; and
a finish on the surface of the central portion of the coupon in which the microscopic ridges are substantially smeared into the microscopic valleys of the coupon.

27. The coupon of claim 26, in which the coupon comprises a seamless aluminum alloy tube having a reduced diameter at the central portion.

28. A process for making a disposable metallic coupon to test the thermal characteristics of a fuel in a fuel testing machine, the process comprising:
providing a cylindrical metallic piece having an outer surface; and
burnishing the outer surface of a central portion of the metallic piece to provide a bright and highly reflective surface finish.

29. A disposable metallic coupon formed by the process of claim 28.

30. The process of claim 28, further comprising:
providing a burnishing machine having a plurality of equally-spaced tapered rollers that roll around and bear against an inversely tapered inside surface of a rotating mandrel;
inserting the metallic piece between the tapered rollers inside the rotating mandrel; and
drawing the tapered rollers inwardly against the outer surface of the metallic piece to provide a steady rolling pressure against the outer surface of the metallic piece.

31. A disposable metallic coupon formed by the process of claim 30.

32. The process of claim 30, further comprising applying sufficient rolling pressure against the outer surface of the metallic piece to work harden the outer surface of the piece.

33. A disposable metallic coupon formed by the process of claim 32.

34. The process of claim 32, where the metallic piece is a hollow tube having a diameter and two end portions, the process further comprising:
reducing the diameter of the central portion of the hollow tube; and
burnishing the end portions of the tube.

35. A disposable heater tube formed by the process of claim 34.

36. The process of claim 34, further comprising connecting an inverter to the burnishing machine, the burnishing machine having a minimum operating rotational speed, to reduce the minimum operating rotational speed of the burnishing machine.

37. A process for making a metallic coupon to test the thermal characteristics of a fuel in a fuel testing machine, the process comprising:
providing a cylindrical metallic piece having an outer surface; and
work-hardening the outer surface of a central portion of the metallic piece to provide a bright and highly reflective surface finish.

38. A process for making a metallic coupon to test the thermal characteristics of a fuel in a fuel testing machine, the process comprising:
providing a cylindrical metallic piece having an outer surface, the outer surface being originally characterized by microscopic ridges and valleys; and
displacing the microscopic ridges into the microscopic valleys of the outer surface of a central portion of the metallic piece to provide a bright and highly reflective surface finish.

39. A process for making a metallic coupon to test the thermal characteristics of a fuel in a fuel testing machine, the process comprising:
means for forming a cylindrical metallic piece having an outer surface; and
means for finishing the outer surface of a central portion of the metallic piece to provide a bright and highly reflective surface finish.

40. A method of testing the thermal characteristics of a fuel, the method comprising:
providing a metallic coupon having a burnished surface;
heating the metallic coupon to a temperature sufficient to cause partial oxidation of fuel coming into contact with the burnished surface;
passing pressurized fuel around the burnished surface of the coupon for a sufficient length of time to permit deposits of fuel degradation products onto the burnished surface, where the fuel degradation products are caused by the partial oxidation of the fuel under high heat and pressure conditions; and
evaluating the fuel degradation deposits on the burnished surface to test the thermal characteristics of the fuel.

41. The method of claim 40, further comprising cleaning the burnished surface before heating the metallic coupon.

42. The method of claim 40, where the metallic coupon comprises a hollow elongated tube.

43. The method of claim 40, where the action of evaluating the fuel degradation deposits comprises measuring the depth of the deposits with a machine.

44. The method of claim 43, where the machine comprises an ellipsometric tube analyzer.

45. A method of testing the thermal characteristics of a fuel, the method comprising:
providing a metallic coupon having a work-hardened surface;
heating the metallic coupon to a temperature sufficient to cause partial oxidation of fuel coming into contact with the work-hardened surface;
passing pressurized fuel around the work-hardened surface of the coupon for a sufficient length of time to permit deposits of fuel degradation products onto the work-hardened surface, where the fuel degradation products are caused by the partial oxidation of the fuel under high heat and pressure conditions; and
evaluating the fuel degradation product deposits on the work-hardened surface to test the thermal characteristics of the fuel.

46. A method of testing the thermal characteristics of a fuel, the method comprising:
providing a metallic coupon having a surface originally characterized by microscopic ridges and valleys, the surface being finished by substantially smearing the microscopic ridges into the microscopic valleys of the surface;
heating the metallic coupon to a temperature sufficient to cause partial oxidation of fuel coming into contact with the surface;
passing pressurized fuel around the surface of the coupon for a sufficient length of time to permit deposits of fuel degradation products onto the surface, where the fuel degradation products are caused by the partial oxidation of the fuel under high heat and pressure conditions; and
evaluating the fuel degradation. product deposits on the surface to test the thermal characteristics of the fuel.

47. A disposable coupon for evaluation of thermal characteristics of fuels in a fuel testing machine, comprising:
a seamless cylindrical metallic tube comprised of a 6061 alloy of aluminum, the tube having a reduced-diameter central portion that provides a substrate onto which partially oxidized fuel degradation products are deposited; and
a work-hardened, burnished surface finish on the central portion of the tube that facilitates visual inspection and rating of the fuel degradation product deposits, where the burnished surface finish has a bright, smooth, and highly reflective appearance and is consistent and uniform across the central portion of the tube.

48. A process for making a finished heater tube for evaluation of thermal characteristics of fuels in a fuel testing machine, the process comprising:
providing a raw heater tube having a reduced-diameter central portion and an outer surface;
providing a burnishing machine having a plurality of equally-spaced tapered rollers that roll around and bear against an inversely tapered inside surface of a rotating mandrel;
inserting the raw heater tube between the tapered rollers inside the rotating mandrel;
drawing the tapered rollers inwardly against the outer surface of the raw heater tube to provide a steady rolling pressure against the outer surface of the raw heater tube; and
applying sufficient rolling pressure against the outer surface of the raw heater tube to work harden the outer surface of the raw heater tube.

49. A finished heater tube formed by the process of claim 48.
